(19) United States
(12) Patent Application Publication
(10) Pub. No.: US 2024/0231136 A9
(43) Pub. Date: Jul. 11, 2024

(54) METHOD FOR INSPECTING SEMICONDUCTOR DEVICE

(71) Applicant: Japan Display Inc., Tokyo (JP)

(72) Inventors: Masayuki IKARI, Tokyo (JP); Akihiko FUJISAWA, Tokyo (JP)

(21) Appl. No.: 18/490,130

(22) Filed: Oct. 19, 2023

(30) Foreign Application Priority Data
Oct. 25, 2022 (JP) 2022-170712

(51) Int. Cl. G02F 1/13; G09G 3/00

(52) U.S. Cl. CPC G02F 1/1309; G09G 3/006

(57) ABSTRACT

A method for inspecting a semiconductor device in which each of a plurality of reflective elements includes a liquid crystal. The method includes the steps of acquiring a first capacitance corresponding to each of the plurality of reflective elements after inputting a first voltage signal to the semiconductor device so that a dielectric constant of the liquid crystal is in a predetermined first state in each of the plurality of reflective elements, acquiring a second capacitance corresponding to each of the plurality of reflective elements after inputting a second voltage signal to the semiconductor device so that a dielectric constant of the liquid crystal is in a predetermined second state in each of the plurality of reflective elements, calculating a difference value between the first capacitance and the second capacitance, and determining whether the difference value is less than or equal to a predetermined threshold value.

### CROSS-REFERENCE TO RELATED APPLICATIONS

This application claims the benefit of priority to Japanese Patent Application No. 2022-170712, filed on Oct. 25, 2022, the entire contents of which are incorporated herein by reference.

### FIELD

An embodiment of the present invention relates to a method for inspecting a semiconductor device, particularly, a semiconductor device using liquid crystals.

### BACKGROUND

Conventionally, in an inspection of a liquid crystal display, the liquid crystal display is driven and the display state is observed visually or by automated optical inspection (AOI) using a camera. In recent years, however, the use of liquid crystals has expanded not only to a display device such as a liquid crystal display, but also to a non-display device such as a liquid crystal antenna or a liquid crystal lens. Since such non-display devices include, for example, non-transparent patch electrodes and are not devices intended for display, it is difficult to detect defects in the non-display device by observing the display state. On the other hand, Japanese laid-open patent publication No. 2001-296326 discloses an inspection method using capacitance that can be applied to conductive patterns such as metal.

### SUMMARY

A method for inspecting a semiconductor device according to an embodiment of the present invention is an inspection method of the semiconductor in which a plurality of reflective elements arranged in a matrix in an x direction and a y direction intersecting the x-direction is included and each of the plurality of reflective elements includes a liquid crystal. The method includes the steps of placing a sensor head including a plurality of sensor electrodes over the semiconductor device, acquiring a first capacitance corresponding to each of the plurality of reflective elements via the plurality of sensor electrodes after inputting a first voltage signal to the semiconductor device so that a dielectric constant of the liquid crystal is in a predetermined first state in each of the plurality of reflective elements, acquiring a second capacitance corresponding to each of the plurality of reflective elements via the plurality of sensor electrodes after inputting a second voltage signal to the semiconductor device so that a dielectric constant of the liquid crystal is in a predetermined second state in each of the plurality of reflective elements, calculating a difference value between the first capacitance and the second capacitance, and determining whether the difference value is less than or equal to a predetermined threshold value.

Further, a method for inspecting a semiconductor device according to an embodiment of the present invention is an inspection method of the semiconductor in which a plurality of reflective elements arranged in a matrix in an x direction and a y direction intersecting the x-direction is included and each of the plurality of reflective elements includes a liquid crystal. The method includes the steps of placing a sensor head including a plurality of sensor electrodes in a matrix in an x direction and a y direction over the semiconductor device, acquiring a capacitance corresponding to each of the plurality of reflective elements via the plurality of sensor electrodes after inputting voltage signals to the semiconductor device so that a dielectric constant of the liquid crystal of one of two adjacent reflective elements in the x direction and the y direction is in a predetermined first state in the plurality of reflective elements and a dielectric constant of the liquid crystal of another of the two adjacent reflective elements is in a predetermined second state, calculating a difference value between capacitances of the two adjacent reflective elements in each of the x direction and the y direction, and determining whether the difference value is less than or equal to a predetermined threshold value.

Further, a method for inspecting a semiconductor device according to an embodiment of the present invention is an inspection method of the semiconductor in which a plurality of reflective elements arranged in a matrix in an x direction and a y direction intersecting the x-direction is included and each of the plurality of reflective elements includes a liquid crystal. The method includes the steps of placing a sensor head including a plurality of sensor electrodes in a matrix in an x direction and a y direction over the semiconductor device, acquiring a capacitance corresponding to each of the plurality of reflective elements via the plurality of sensor electrodes after inputting voltage signals to the semiconductor device so that a dielectric constant of the liquid crystal of one of two adjacent reflective elements in the x direction is in a predetermined first state in the plurality of reflective elements and a dielectric constant of the liquid crystal of another of the two adjacent reflective elements is in a predetermined second state, calculating a difference value between capacitances of the two adjacent reflective elements in the x direction, and determining whether the difference value is less than or equal to a predetermined threshold value.

### BRIEF DESCRIPTION OF DRAWINGS

FIG. 1 is a schematic diagram showing a configuration of an inspection device used in a method for inspecting a semiconductor device according to an embodiment of the present invention.

FIG. 2 is a block diagram showing a configuration of an inspecting device used in a method for inspecting a semiconductor device according to an embodiment of the present invention.

FIG. 3 is a schematic circuit diagram illustrating a detection of capacitance by a sensor electrode in a method for inspecting a semiconductor device according to an embodiment of the present invention.

FIG. 4 is a schematic diagram illustrating capacitance corresponding to a reflective element in a method for inspecting a semiconductor device according to an embodiment of the present invention.

FIG. 5 is a flowchart showing a method for inspecting a semiconductor device according to an embodiment of the present invention.

FIG. 6 is a schematic diagram showing voltage signals input to reflective elements of a semiconductor device in a method for inspecting a semiconductor device according to the embodiment of the present invention.

FIG. 7 is a schematic diagram showing a difference value calculated when a reflective element has a defect in a method for inspecting a semiconductor device according to an embodiment of the present invention.

FIG. 8 is a schematic diagram showing a difference value calculated when a reflective element has a defect in a method for inspecting a semiconductor device according to an embodiment of the present invention.

FIG. 9 is a schematic diagram showing a difference value calculated when a reflective element has a defect in a method for inspecting a semiconductor device according to an embodiment of the present invention.

FIG. 10 is a flowchart showing a method for inspecting a semiconductor device according to an embodiment of the present invention.

FIG. 11 is a schematic diagram showing voltage signals input to reflective elements of a semiconductor device in a method for inspecting a semiconductor device according to an embodiment of the present invention.

FIG. 12 is a schematic diagram showing difference values calculated when a reflective element has a defect in a method for inspecting a semiconductor device according to an embodiment of the present invention.

FIG. 13 is a schematic diagram showing difference values calculated when a reflective element has a defect in a method for inspecting a semiconductor device according to an embodiment of the present invention.

FIG. 14 is a flowchart showing a method for inspecting a semiconductor device according to an embodiment of the present invention.

FIG. 15 is a schematic diagram showing voltage signals input to reflective elements of a semiconductor device in a method for inspecting a semiconductor device according to an embodiment of the present invention.

FIG. 16 is a schematic diagram showing difference values calculated when a reflective element has a defect in a method for inspecting a semiconductor device according to an embodiment of the present invention.

FIG. 17 is a schematic diagram showing a configuration of an inspection device used in a method for inspecting a semiconductor device according to an embodiment of the present invention.

FIG. 18 is a schematic circuit diagram illustrating a detection of capacitance by a first sensor electrode and a second sensor electrode in a method for inspecting a semiconductor device according to the embodiment of the present invention.

FIG. 19 is a schematic diagram illustrating capacitance corresponding to a reflective element in a method for inspecting a semiconductor device according to an embodiment of the present invention.

### DESCRIPTION OF EMBODIMENTS

In Japanese laid-open patent publication No. 2001-296326, after a DC voltage is applied to a conductive pattern of a semiconductor device, a detection electrode arranged to face the conductive pattern is vibrated in the vertical direction. Then, the presence or absence of a defect in the conductive pattern is determined by detecting changes in capacitance between the conductive pattern and the detection electrode. In the method disclosed in Japanese laid-open patent publication No. 2001-296326, however, it is necessary to detect capacitance by the detection electrode for each conductive pattern. Therefore, it takes time to inspect the semiconductor device, and as a result, the cost of the semiconductor device increases.

In view of the above problem, one object of an embodiment of the present invention is to provide a method for inspecting a semiconductor device that can easily determine a defect in a semiconductor device using liquid crystal.

Hereinafter, each of the embodiments of the present invention is described with reference to the drawings. The following disclosure is merely an example. A person skilled in the art could easily conceive of the invention by appropriately changing the embodiment while maintaining the gist of the invention, and such changes are naturally included in the scope of the invention. For the sake of clarity of the description, the drawings may be schematically represented with respect to the widths, thicknesses, shapes, and the like of the respective portions in comparison with actual embodiments. However, the illustrated shapes are merely examples and are not intended to limit the interpretation of the present invention. In the specification and the drawings, the same reference numerals are provided to the same elements as those described previously with reference to preceding figures and detailed explanations may be omitted accordingly.

In the specification, the direction from the substrate toward the sensor head is referred to as “above” or “above direction”, with reference to the time when the inspecting method of the semiconductor device is implemented. Conversely, the direction from the sensor head toward the substrate is referred to as “below” or “below direction”. In this way, in principle, it is defined as above or below based on the positional relationship between the substrate and the sensor head, but in some cases, the above-mentioned vertical relationship may be reversed.

In the present specification, the expressions “α includes A, B or C”, “α includes any of A, B and C”, and “α includes one selected from the group consisting of A, B and C” do not exclude the case where α includes a plurality of combinations of A to C unless otherwise specified. Further, these expressions do not exclude the case where α includes other elements.

In the present specification, the term “a reflective element” refers to the minimum unit defined or substantially defined such that the alignment of liquid crystals is controlled. For example, in a liquid crystal reflector, “a reflective element” is a unit that includes an area defined or substantially defined to include a liquid crystal material sandwiched between one patch electrode and one common electrode. However, any element in any semiconductor device other than the liquid crystal reflector that includes a structure equivalent to a “a reflective element” can be considered to be equivalent to a “a reflective element”. For example, in a liquid crystal display, one pixel corresponds to the above minimum unit.

In addition, the following embodiments can be combined with each other as long as there is no technical contradiction.

### First Embodiment

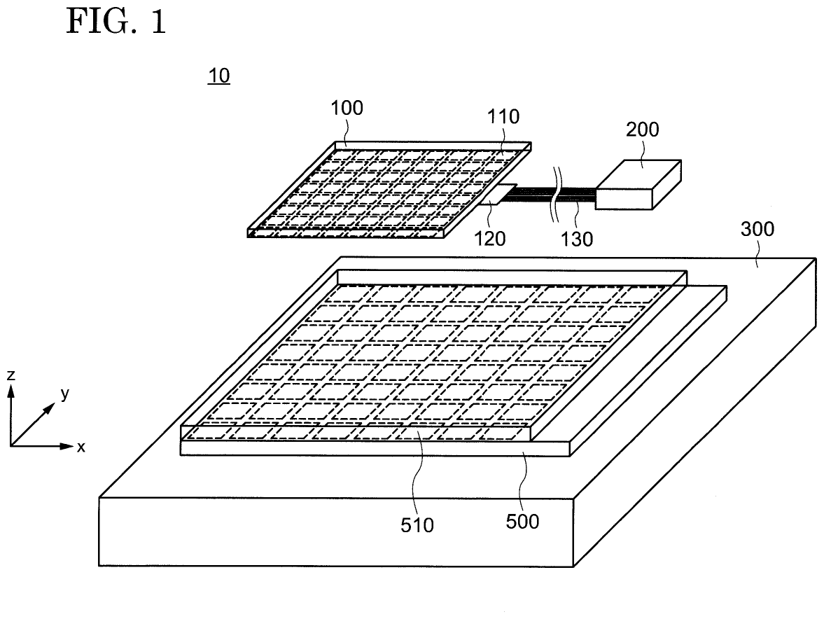

A method for inspecting a semiconductor device according to an embodiment of the present invention is described with reference to FIGS. 1 to 9.

### [1. Configuration of Inspection Device]

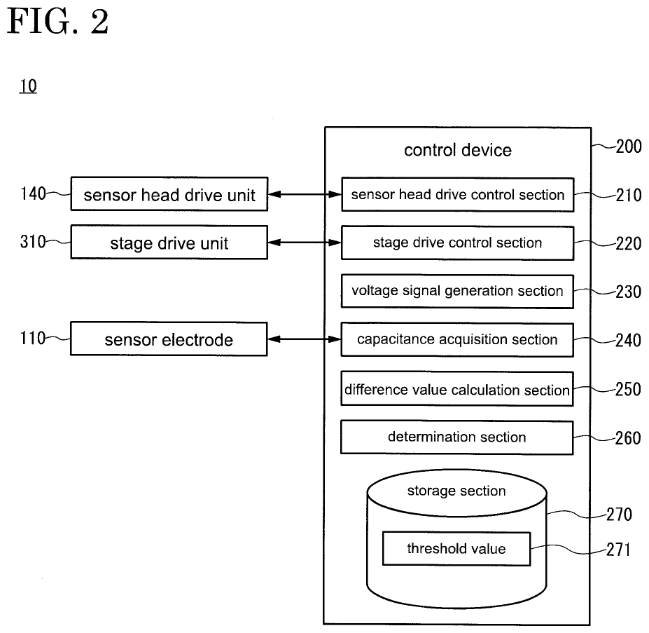

In a method for inspecting a semiconductor device according to an embodiment of the present invention, a inspecting device 10 is used. Therefore, a configuration of the inspection device 10 is described with reference to FIGS. 1 and 2.

FIG. 1 is a schematic diagram showing the configuration of the inspection device 10 used in a method for inspecting a semiconductor device according to an embodiment of the present invention. FIG. 2 is a block diagram showing the configuration of the inspection device 10 used in a method for inspecting a semiconductor device according to an embodiment of the present invention.

As shown in FIG. 1, the inspection device 10 includes a sensor head 100, a control device 200, and a stage 300. The sensor head 100 includes a plurality of sensor electrodes 110 arranged in a matrix in an x direction and in a y direction intersecting the x direction. A semiconductor device 500 to be inspected by the inspection device 10 is placed on the stage 300. The semiconductor device 500 includes a plurality of reflective elements 510 arranged in a matrix in the x and y directions. When the semiconductor device 500 is inspected, the sensor head 100 is placed over the semiconductor device 500 (in a z direction intersecting the x direction and the y direction). Specifically, when the semiconductor device 500 is inspected, the sensor head 100 is placed close to the semiconductor device 500 so that the plurality of sensor electrodes 110 faces the plurality of reflective elements 510. That is, it is not necessary to bring the plurality of sensor electrodes 110 in contact with the semiconductor device 500, and the semiconductor device 500 can be inspected in a non-contact manner.

Although the semiconductor device 500 includes a liquid crystal, and is, a liquid crystal display device, a liquid crystal antenna, or a liquid crystal lens, for example, the semiconductor device 500 is not limited thereto. The plurality of reflective elements 510 includes a liquid crystal and a patch electrode that applies a voltage to the liquid crystal (in particular, a patch electrode that controls the alignment of the liquid crystal). The patch electrode may be transparent or non-transparent.

Although not shown in FIG. 1, the sensor head 100 is provided with a sensor head drive unit 140 that can move the sensor head 100 in the x direction and they direction (see FIG. 2). Therefore, the sensor head 100 can move in the x-direction and the y-direction. Although not shown in FIG. 1, the stage 300 is provided with a stage drive unit 310 that can move the stage 300 in the x direction and the y direction (see FIG. 2). Therefore, the semiconductor device 500 placed on the stage 300 can be moved in the x direction and the y direction. Although the details are described later, the inspection using the inspection device 10 utilizes capacitance detected by the plurality of sensor electrodes 110. Therefore, the capacitance between the sensor head 100 and the semiconductor device 500 is detected using the plurality of sensor electrodes 110 while the sensor head 100 or the stage 300 is moved in the x direction or the y direction.

In at least one of the x-direction and the y-direction, the width of each of the plurality of sensor electrodes 110 is smaller than the width of the reflective element 510, preferably smaller than the width of the patch electrode. Thus, the capacitance corresponding to one reflective element 510 is detected by some electrodes of the plurality of sensor electrodes 110. Therefore, the sensor head 100 or the stage 300 is moved in the x direction or the y direction so that the plurality of sensor electrodes 110 included in the sensor head 100 can detect the capacitances corresponding to all the reflective elements 510.

A terminal portion 120 is provided in the sensor head 100. The plurality of sensor electrodes 110 are electrically connected to a plurality of terminals of the terminal portion 120, respectively. The terminal portion 120 is also electrically connected to the control device 200 via a connection portion 130. Therefore, a signal detected by each of the plurality of sensor electrodes 110 (specifically, a signal corresponding to the capacitance) is input to the control device 200 via the terminal portion 120 and the connection portion 130. The signal from the control device 200 can also be input to the sensor head 100.

As shown in FIG. 2, the control device 200 includes a sensor head drive control section 210, a stage drive control section 220, a voltage signal generation section 230, a capacitance acquisition section 240, a difference value calculation section 250, a determination section 260, and a storage section 270. The control device 200 is a so-called computer, and functions by executing a predetermined program. The control device 200 includes, for example, a central processing unit (CPU), a microprocessor (MPU), or an image processing unit (GPU) that performs arithmetic processing using data or information. The control device 200 also includes a storage device such as a random access memory (RAM), a read only memory (ROM), a flash memory, a hard disk drive (HDD), or a solid state drive (SSD), or a communication interface.

The sensor head drive control section 210 is connected to the sensor head drive unit 140 and can transmit control signals to the sensor head drive unit 140. The sensor head drive unit 140 moves the sensor head 100 in the x-direction and the y-direction based on the control signals transmitted from the sensor head drive control section 210.

The stage driving control section 220 is connected to the stage driving section 310 and can transmit control signals to the stage driving section 310. The stage drive section 310 moves the stage 300 in the x direction and the y direction based on the control signals transmitted from the stage drive control section 220.

The voltage signal generation section 230 can generate a voltage signal that is input to the sensor head 100 and the semiconductor device 500. For example, the voltage signal generation unit 230 can generate a DC voltage signal or an AC (rectangular wave) voltage signal.

The capacitance acquisition section 240 can acquire the capacitance corresponding to each of the plurality of reflective elements 510 via the plurality of sensor electrodes 110. Although the details are described later, in the inspection of the semiconductor device 500, the capacitances are detected using the plurality of sensor electrodes 110 while the voltage signal is input to each of the plurality of reflective elements 510. The capacitance acquisition unit 240 sums up one or several capacitances detected by the plurality of sensor electrodes 110 for each of the plurality of reflective elements 510, and acquires the capacitance corresponding to each of the plurality of reflective elements 510. In addition, the acquired capacitance corresponding to each of the plurality of reflective elements 510 can be stored in the storage section 270.

The difference value calculation section 250 can calculate the difference value between the two capacitances acquired by the capacitance acquisition unit 240. For example, the difference value calculation unit 250 can calculate the difference value between the first capacitance acquired when a first voltage signal is input to the reflective element 510 and the second capacitance acquired when a second voltage signal is input to the reflective element 510.

The determination section 260 can determine whether the semiconductor device 500 includes a defect based on the difference value calculated by the difference value calculation section 250. Specifically, the determination section 260 compares the calculated difference value with a threshold value 271 stored in the storage section 270, and determines whether the semiconductor device 500 has a defect. In addition, the threshold value 271 can be freely set by the user.

### [2. Acquisition of Capacitance Corresponding to Reflective Element]

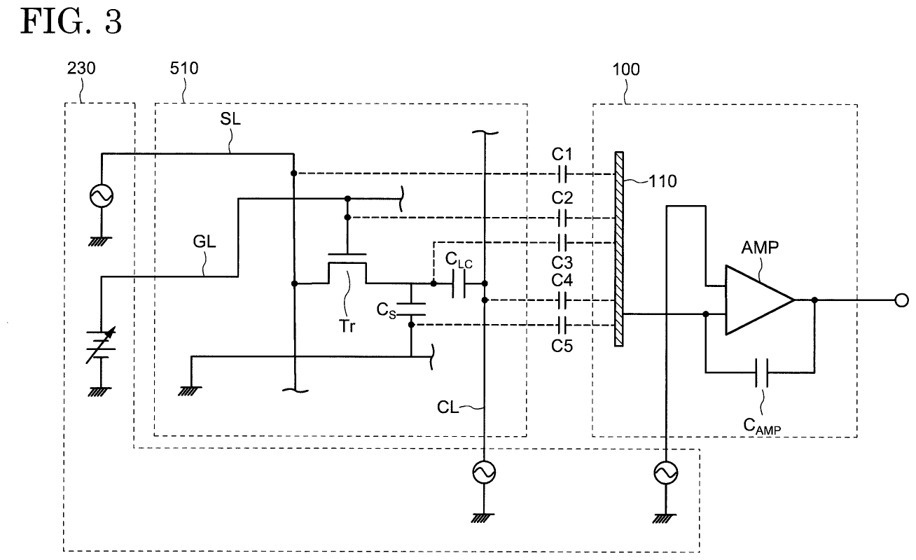

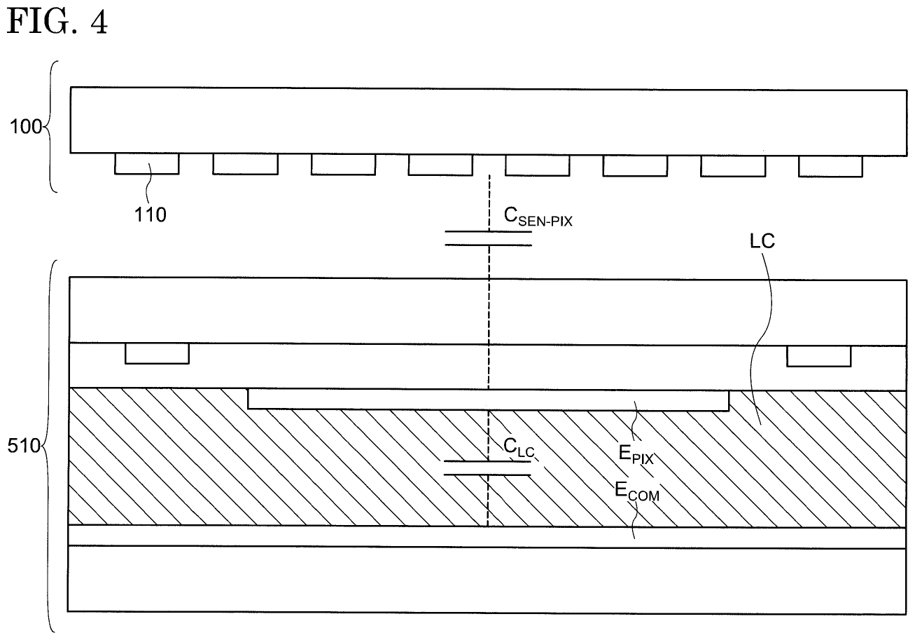

The acquisition of the capacitance corresponding to the reflective element 510 is described with reference to FIGS. 3 and 4.

FIG. 3 is a schematic circuit diagram illustrating a detection of the capacitance of the sensor electrode 110 in a method for inspecting a semiconductor device according to an embodiment of the present invention.

FIG. 3 shows a detection circuit of the sensor head 100 and a reflective element circuit of the reflective element 510. In addition, the detection circuit and the reflective element circuit are not limited to the configuration shown in FIG. 3. Further, FIG. 3 shows one sensor electrode 110 with respect to one reflective element 510, for convenience of explanation.

The detection circuit shown in FIG. 3 includes the sensor electrode 110, an amplifier AMP, and a compensation capacitor C_{AMP}. The signal detected by the sensor electrode 110 is amplified by the amplifier AMP and output.

The reflective element circuit shown in FIG. 3 includes a liquid crystal capacitor C_{LC}, a holding capacitor C_{S}, a transistor Tr, a common line CL, a gate line GL, and a signal line SL. A common electrode which is one of the pair of electrodes forming the liquid crystal capacitor C_{LC} is connected to the common line CL, and a patch electrode which is the other of the pair of electrodes forming the liquid crystal capacitor C_{LC} is connected to the source electrode and the drain of the transistor Tr. The other of the source electrode and the drain electrode of the transistor Tr is connected to the signal line SL. Further, a gate line GL is connected to the gate electrode of the transistor Tr. One of the pair of electrodes forming the holding capacitor Cs is connected to the patch electrode and one of the source electrode and the drain electrode, and the other of the pair of electrodes forming the holding capacitor Cs is grounded.

The AC voltage signal generated by the voltage signal generation section 230 is input to the amplifier AMP of the detection circuit, the common line CL, and the signal line SL. Further, the DC voltage signal generated by the voltage signal generator 230 is input to the gate electrode. In addition, when the semiconductor device 500 includes a gate drive circuit and a source drive circuit, each voltage signal is input to the reflective element 510 via the gate drive circuit and the source drive circuit.

When the sensor electrode 110 is brought close to the reflective element 510, various capacitances are generated between the sensor electrode 110 and the reflective element 510. For example, capacitance C1 is a capacitance formed between the sensor electrode 110 and the signal line SL, capacitance C2 is a capacitance formed between the sensor electrode 110 and the gate line GL, and capacitance C3 is a capacitance formed between the sensor electrode 110 and the patch electrode, capacitance C4 is a capacitance formed between the sensor electrode 110 and the common electrode or the common line, and capacitance C5 is a capacitance formed between the sensor electrode 110 and the ground line. In this manner, the inspection device 10 can detect capacitance using a so-called self-capacitance method, in which the capacitance is formed by bringing the sensor electrodes 110 close to the reflective element 510. The signal output from the sensor electrode 110 is the sum of all capacitances (e.g., capacitances C1 to C5, etc.) formed between the sensor electrode 110 and the reflective element 510.

FIG. 4 is a schematic diagram illustrating a capacitance corresponding to the reflective element 510 in a method for inspecting a semiconductor device according to an embodiment of the present invention.

Although it is described in FIG. 3 that one reflective element 510 corresponds to one sensor electrode 110, in reality a plurality of sensor electrodes 110 faces one the reflective elements 510, as shown in FIG. 4.

As shown in FIG. 4, a liquid crystal capacitance C_{LC} is formed by the liquid crystal LC sandwiched between the patch electrode E_{PIX} and the common electrode E_{COM}. Further, although the capacitance formed between each sensor electrode 110 and one reflective element 510 is as described above, in one reflective element 510, the capacitance C_{SEN-PIX} can be considered to be formed by the sum of the capacitances of the plurality of sensor electrodes 110 corresponding to one reflective element 510. Therefore, the plurality of sensor electrodes 110 corresponding to one reflective element 510 detects the capacitance C_{SEN-PIX} and the capacitance C_{LC} that are connected in series. That is, the plurality of sensor electrodes 110 corresponding to the reflective element 510 can detect the capacitance C_{det} represented by Equation (1).

$$\begin{matrix}[ Equation 1 ] & \\ {C}_{det} = \frac{{C}_{SEN - PIX} {C}_{LC}}{{C}_{SEN - PIX} + {C}_{LC}} & ( 1 )\end{matrix}$$

When the state of the liquid crystal LC changes, the liquid crystal capacitance C_{LC} changes. Thus, as understood from the equation (1), when the state of the liquid crystal LC changes, the capacitance C_{det} detected by the plurality of sensor electrodes 110 changes. Therefore, the capacitance acquisition section 240 can acquire the capacitance C_{det} corresponding to the reflective element 510 by selecting the plurality of sensor electrodes 110 corresponding to the reflective element 510.

### [3. Inspection Method of Semiconductor Device]

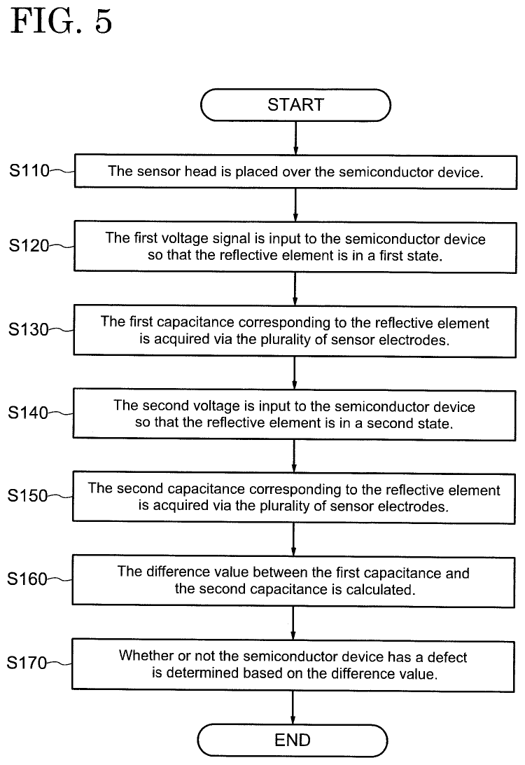

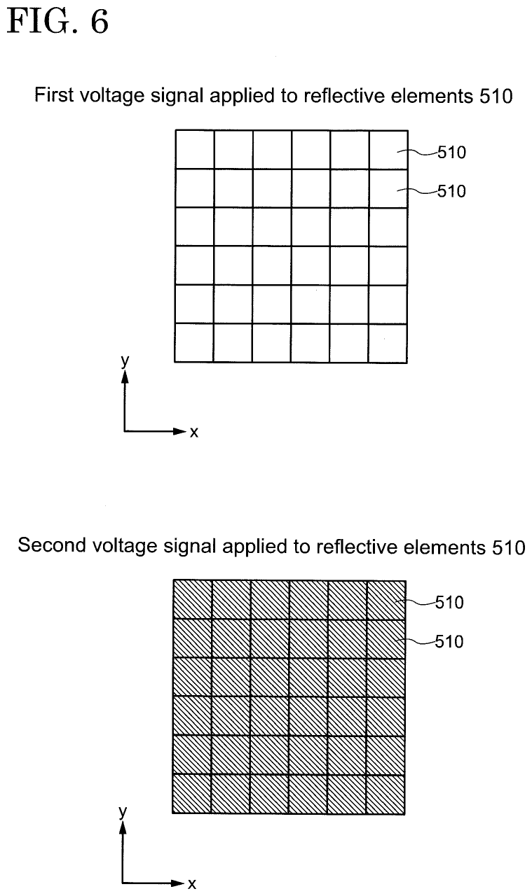

FIG. 5 is a flowchart showing a method for inspecting a semiconductor device according to an embodiment of the present invention. FIG. 6 is a schematic diagram showing voltage signals input to the reflection elements 510 of the semiconductor device 500 in a method for inspecting a semiconductor device according to an embodiment of the present invention. In addition, FIG. 6 shows 6×6 reflective elements 510 for convenience.

The flowchart shown in FIG. 5 includes steps S110 to S170. Hereinafter, steps S110 to S170 are described in order.

In step S110, the sensor head 100 is placed over the semiconductor device 500. Specifically, the sensor head 100 is placed close to the semiconductor device 500 so that the plurality of sensor electrodes 110 faces the reflective element 510. In order to acquire capacitances corresponding to all the reflective elements 510 in the semiconductor device 500, the sensor head 100 or the stage 300 is moved as appropriate. The movement of the sensor head 100 is executed based on the control signal from the sensor head drive control section 210. Further, the movement of the stage 300 is executed based on the control signal from the stage drive control section 220.

In step S120, the first voltage signal is input to the semiconductor device 500 so that the dielectric constant of the liquid crystal in the reflective element 510 is in a predetermined first state (hereinafter, it may be referred to as the first state of the reflective element 510). The first voltage signal is generated by the voltage signal generation section 230. The first voltage signal is applied to the patch electrode of each of the plurality of reflective elements 510, for example. Here, the predetermined first state refers to a state in which the liquid crystal sandwiched between the patch electrode and the common electrode in the liquid crystal reflector has the smallest dielectric constant. That is, the first voltage signal is a voltage signal that maintains the liquid crystal in the predetermined first state (see FIG. 6).

In addition, the first voltage signal in step S120 may be input for a predetermined time.

In step S130, the first capacitance C_{det-1} corresponding to the reflective element 510 is acquired via the plurality of sensor electrodes 110. The first capacitance C_{det-1} is a capacitance corresponding to the state of the liquid crystal when the first voltage signal is applied. Specifically, the capacitance acquisition section 240 selects the sensor electrodes 110 corresponding to one reflective element 510, and sums the capacitances detected by the selected sensor electrodes 110 to acquire the first capacitance C_{det-1}. Similarly, the first capacitance C_{det-1} of each of the plurality of reflective elements 510 included in the semiconductor device 500 is acquired. The acquired first capacitance C_{det-1} of each of the plurality of reflective elements 510 is stored in the storage section 270.

In step S140, the second voltage signal is input to the semiconductor device 500 so that the dielectric constant of the liquid crystal in the plurality of reflective elements 510 is in a predetermined second state (hereinafter, it may be referred to as the second state of the reflective element 510). The second voltage signal is generated by the voltage signal generation section 230. The second voltage signal is also applied to the patch electrode of each of the plurality of reflective elements 510, for example. Here, the predetermined second state is a state in which the liquid crystal sandwiched between the patch electrode and the common electrode in the liquid crystal reflecting plate has the largest dielectric constant. That is, the second voltage signal is a voltage signal that changes the liquid crystal to the predetermined second state (see FIG. 6).

In addition, the input of the second voltage signal in step S140 is performed only for a predetermined time. Here, the predetermined time is the time during which the liquid crystal changes from an initial alignment state to another alignment state, and may be set by the user as appropriate.

In step S150, the second capacitance C_{det-2} corresponding to the reflective element 510 is acquired via the plurality of sensor electrodes 110. The second capacitance C_{det-2} is a capacitance that corresponds to the state of the liquid crystal when the second voltage signal is applied. Specifically, the capacitance acquisition section 240 selects the sensor electrode 110 corresponding to one reflective element 510, and sums the capacitances detected by the selected sensor electrodes 110 to acquire the second capacitance C_{det-2}. Similarly, the second capacitance C_{det-2} of each of the plurality of reflective elements 510 included in the semiconductor device 500 is acquired. The acquired second capacitance C_{det-2} of each of the plurality of reflective elements 510 is stored in the storage section 270.

In step S160, the difference value (absolute value) between the first capacitance C_{det-1} and the second capacitance C_{det-2} is calculated.

In step S170, the determination section 260 determines whether or not the semiconductor device 500 has a defect based on the difference value. Specifically, the determination section 260 determines whether the difference value is less than or equal to a threshold value. When the semiconductor device 500 has a defect, the difference value is small. Therefore, when the difference value is less than or equal to the threshold value, the determination section 260 determines that the semiconductor device 500 is a defective product. On the other hand, when the difference value exceeds the threshold, the determination section 260 determines that the semiconductor device 500 is a normal product.

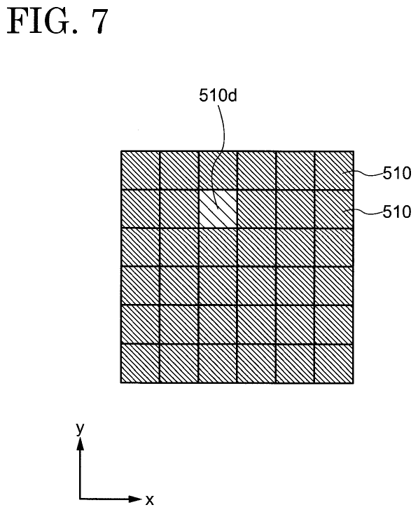

Here, the decrease in the difference value reflecting the defect of the semiconductor device 500 is described with reference to FIGS. 7 to 9.

FIGS. 7 to 9 are schematic diagrams showing difference values calculated when the reflecting element 510 has a defect in a method for inspecting a semiconductor device according to an embodiment of the present invention.

FIG. 7 shows one defective reflective element 510d with a difference value less than or equal to the threshold. When a wiring is disconnected in the reflective element 510d, the second capacitance C_{det-2} acquired in step S150 is close to the first capacitance C_{det-1} because the voltage signal is not sufficiently applied to the liquid crystal in the reflective element 510d in step S140. In this case, since the difference between the first capacitance C_{det-1} and the second capacitance C_{det-2} becomes small, the calculated difference value decreases.

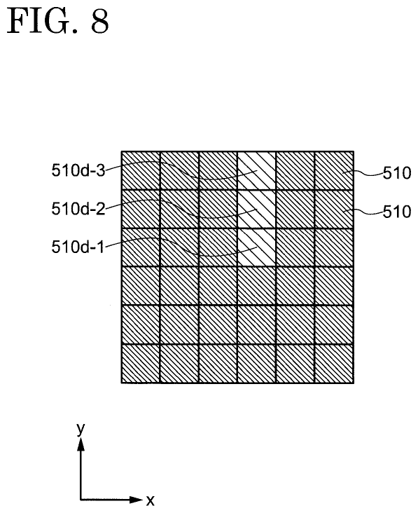

FIG. 8 shows three defective reflective elements 510d with difference values less than or equal to the threshold value from the middle to the edge in the y direction in which the signal line SL extends (the first reflective element 510d-1 to the third reflective element 510d-3). When the signal line SL is disconnected, the second capacitance C_{det-2} acquired in step S150 is close to the first capacitance C_{det-1} because the voltage signal is not sufficiently applied to the liquid crystal in the reflective element 510d in step S140 from the first reflective element 510d-1, in which the disconnection occurs, to the third reflective element 510d-3 at the edge. In this case, since the difference between the first capacitance C_{det-1} and the second capacitance C_{det-2} becomes small, the calculated difference value decreases. Although the defect in the reflective element 510d shown in FIG. 8 does not occur within the reflective element 510d, the defect in the signal line SL is reflected in the capacitance corresponding to the reflective element 510d. Therefore, in a method for inspecting a semiconductor device according to the present embodiment, it is possible to detect not only defects in the reflective element 510 but also defects in the signal line SL.

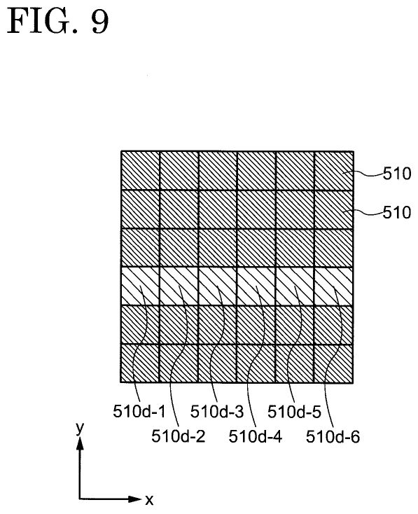

FIG. 9 shows six defective reflective elements 510d with difference values less than or equal to the threshold value all in the x direction in which the gate line GL extends (the first reflective element 510d-1 to the six reflective element 510d-6). When the gate line GL is disconnected, the second capacitance C_{det-2} acquired in step S150 is close to the first capacitance C_{det-1} because the voltage signal is not sufficiently applied to the liquid crystal in all of the reflective elements 510d included in the column in which the disconnection occurs in step S140. In this case, since the difference between the first capacitance C_{det-1} and the second capacitance C_{det-2} becomes small, the calculated difference value decreases. Although the defect in the reflective element 510d shown in FIG. 9 does not occur within the reflective element 510d, the defect in the gate line GL is reflected in the capacitance corresponding to the reflective element 510d. Therefore, in a method for inspecting a semiconductor device according to the present embodiment, it is possible to detect not only defects in the reflective element 510 but also defects in the gate line GL.

The determination section 260 not only determines the threshold value but also determines whether the reflective element 510, the signal line SL, or the gate line GL is defective based on the distribution of the defective reflective elements 510d shown in FIGS. 7 to 9.

As described above, in a method for inspecting a semiconductor device according to an embodiment of the present invention, the capacitance corresponding to each of the plurality of reflective elements 510 of the semiconductor device 500 can be acquired using the sensor head 100 including the plurality of sensor electrodes 110. The capacitance corresponding to the reflective element 510 reflects various defects in the reflective element 510, the signal line SL, and the gate line GL. Therefore, defects in the semiconductor device 500 can be easily determined based on the change in the capacitance corresponding to the reflective element 510.

Hereinafter, several modified examples of a method for inspecting a semiconductor device according to an embodiment of the present invention are described. The modification of a method for inspecting a semiconductor device according to an embodiment of the present invention is not limited to the modifications described below.

### Modification 1

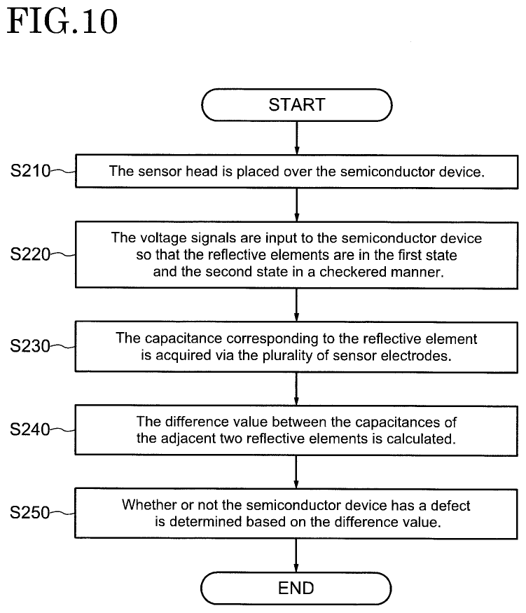

A modification of a method for inspecting a semiconductor device according to an embodiment of the present invention is described with reference to FIGS. 10 to 13. In addition, the description of configurations that are the same as or similar to the above-described configurations may be omitted in the following description.

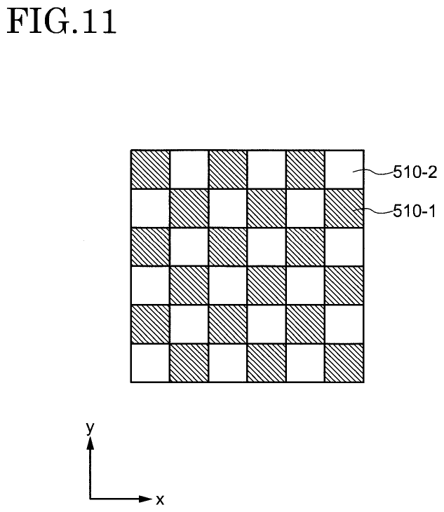

FIG. 10 is a flowchart showing a semiconductor device inspection method according to an embodiment of the present invention. FIG. 11 is a schematic diagram showing voltage signals input to the reflection elements 510 of the semiconductor device 500 in a method for inspecting a semiconductor device according to the embodiment of the present invention.

The flowchart shown in FIG. 10 includes steps S210 to S250. Hereinafter, steps S210 to S250 are described in order.

Since step S210 is the same as step S110, the description thereof is omitted.

In step S220, voltage signals are input to the semiconductor device 500 so that the dielectric constant of the liquid crystal of one of the two reflective elements 510 adjacent in the x direction and the y direction is in the predetermined first state and the dielectric constant of the liquid crystal of the other of the two reflective elements 510 is in the predetermined second state. That is, in step S220, the voltage signals are input to the semiconductor device 500 so that the plurality of reflective elements 510 are in the first state (see the reflective element 510-1 in FIG. 11) and the second state (see the reflective element 510-2 in FIG. 11) in a check pattern.

In addition, the input of the voltage signals in step S220 are performed only for a predetermined time.

In step S230, the capacitance C_{det} corresponding to the reflective element 510 is acquired via the plurality of sensor electrodes 110. Specifically, the capacitance acquisition section 240 selects the sensor electrodes 110 corresponding to one reflective element 510, and sums the capacitances detected by the selected sensor electrodes 110 to acquire the capacitance C_{det}. Similarly, the capacitance C_{det} of each of the plurality of reflective elements 510 included in the semiconductor device 500 is acquired. The acquired capacitance C_{det} of each of the plurality of reflective elements 510 is stored in the storage section 270.

In step S240, the difference value calculation section 250 calculates the difference value (absolute value) between the capacitances of two reflective elements 510 adjacent in the x direction and the y direction. The capacitances of the two reflective elements 510 adjacent in the x-direction and y-direction are the capacitance corresponding to the reflective element 510-1 in the first state and the capacitance corresponding to the reflective element 510-2 in the second state. One reflective element 510 is any of two to four adjacent reflective elements 510 in the x direction and the y direction. Therefore, two to four difference values are acquired for each of the plurality of reflective elements 510.

Since step S250 is similar to step S170, the description is omitted. However, since each of the plurality of reflective elements 510 has two to four difference values, the determination section 260 determines whether any of the two to four difference values is less than or equal to the threshold value.

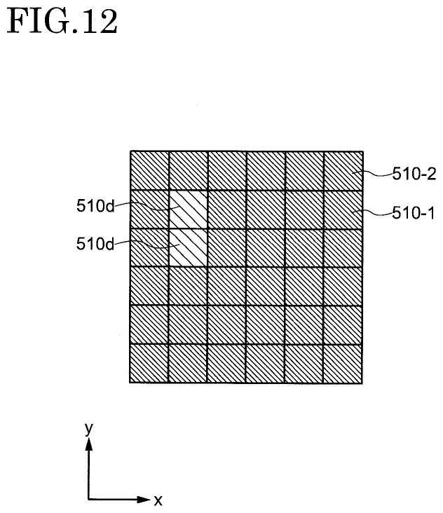

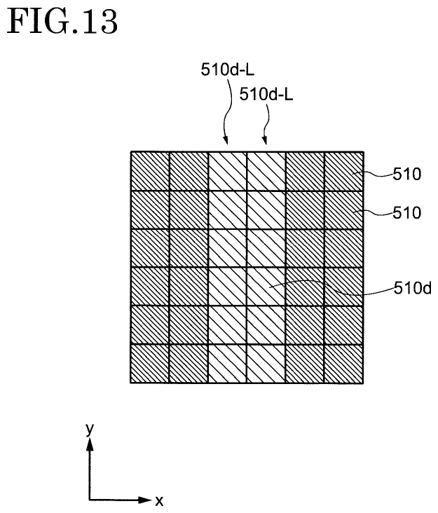

Here, the decrease in the difference value reflecting a defect in the semiconductor device 500 is described with reference to FIGS. 12 and 13.

FIGS. 12 and 13 are schematic diagrams showing difference values calculated when the reflective element 510 has a defect in a method for inspecting a semiconductor device according to an embodiment of the present invention.

FIG. 12 shows two adjacent reflective elements 510d with the difference values less than or equal to the threshold. When two adjacent reflective elements 510d are short-circuited, the voltage signal is not sufficiently applied to the liquid crystal in the reflective element 510d that is in the first state in step S220. Therefore, in the two adjacent reflective elements 510d in which the short circuit occurs, the capacitance C_{det} acquired in step S230 is close to the capacitance C_{det} of the reflective element 510-2 in the second state. In this case, the calculated difference value decreases between the two adjacent reflecting elements 510d.

FIG. 13 shows two adjacent rows of reflective elements 510d-L with the difference values less than or equal to the threshold. When the two signal lines SL extending in the y-direction are short-circuited, the voltage signal is not sufficiently applied to the liquid crystal in the reflective element 510d that is in the first state in step S220. Therefore, in each of the reflective elements 510d-L in the column in which the short circuit occurs, the capacitance C_{det} acquired in step S230 is close to the capacitance C_{det} of the reflective element 510-2 in the second state. In this case, the calculated difference value decreases in two rows of reflecting elements 510-L adjacent in the x direction. Although the defects in the two rows of reflective elements 510d-L shown in FIG. 13 do not occur within the reflective elements 510d, the defect in the signal line SL is reflected in the capacitance corresponding to the reflective elements 510d. Therefore, in a method for inspecting a semiconductor device according to the present modification, it is possible to detect not only defects in the reflective element 510 but also defects in the signal line SL.

### Modification 2

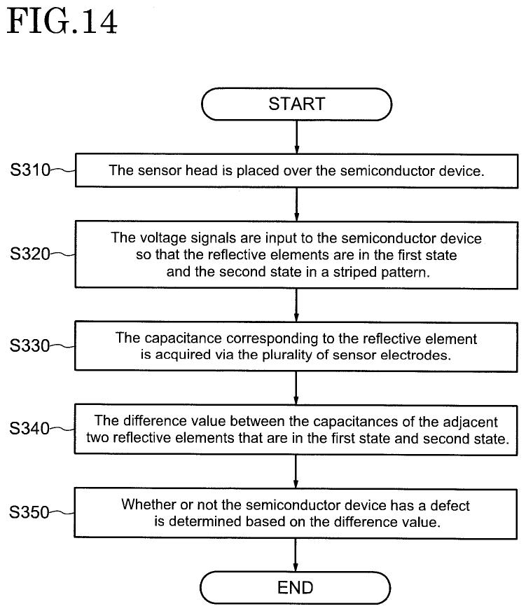

Another modification of a method for inspecting a semiconductor device according to an embodiment of the present invention is described with reference to FIGS. 14 to 16. In addition, the description of configurations that are the same as or similar to the above-described configurations may be omitted in the following description.

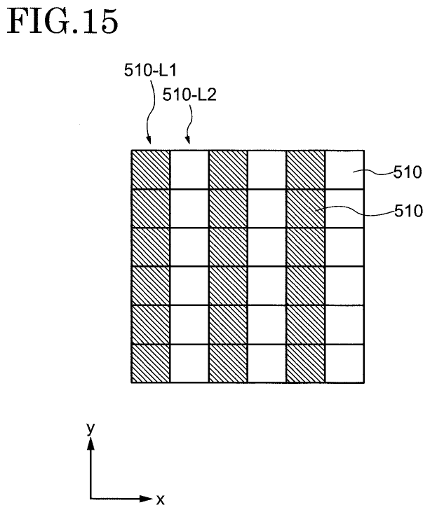

FIG. 14 is a flowchart showing a method for inspecting a semiconductor device according to an embodiment of the present invention. FIG. 15 is a schematic diagram showing voltage signals input to the reflective elements 510 of the semiconductor device 500 in a method for inspecting a semiconductor device according to an embodiment of the present invention. In addition, FIG. 15 shows 6×6 reflective elements 510 for convenience.

The flowchart shown in FIG. 14 includes steps S310 to S350. Hereinafter, steps S310 to S350 are described in order.

Since step S310 is the same as step S110, the description thereof is omitted.

In step S320, voltage signals are input to the semiconductor device 500 so that the dielectric constants of the liquid crystals of the reflective elements 510 in a row along the y direction are in the first state or the second state. Along the x direction, a row of reflective elements 510-L1 in the first state and a row of reflective elements 510-L2 in the second state are alternately arranged. That is, in step S320, the voltage signals are input to the semiconductor device 500 so that the plurality of reflective elements 510 are in the first state and the second state in stripes (see FIG. 15).

In addition, the input of the voltage signals in step S320 is performed only for a predetermined time.

In step S330, the capacitance C_{det} corresponding to the reflective element 510 is acquired via the plurality of sensor electrodes 110. Specifically, the capacitance acquisition section 240 selects the sensor electrodes 110 corresponding to one reflective element 510, and sums the capacitances detected by the selected sensor electrodes 110 to acquire the capacitance C_{det}. Similarly, the capacitance C_{det} of each of the plurality of reflective elements 510 included in the semiconductor device 500 is acquired. The acquired capacitance C_{det} of each of the plurality of reflective elements 510 is stored in the storage section 270.

In step S340, the difference value calculation section 250 calculates the difference value (absolute value) between the capacitances of two reflective elements 510 adjacent in the x direction. The capacitances of two reflective elements 510 adjacent in the x direction are the capacitance corresponding to the reflective element 510 in the first state and the capacitance corresponding to the reflective element 510 in the second state. One reflective element 510 is one or two adjacent reflective elements 510 in the x direction. Therefore, one or two difference values are acquired for each of the plurality of reflective elements 510.

Since step S350 is the same as step S170, the description thereof is omitted. In addition, when the reflective element 510 has the two difference values, the determination section 260 determines whether both of the two difference values are less than or equal to the threshold value.

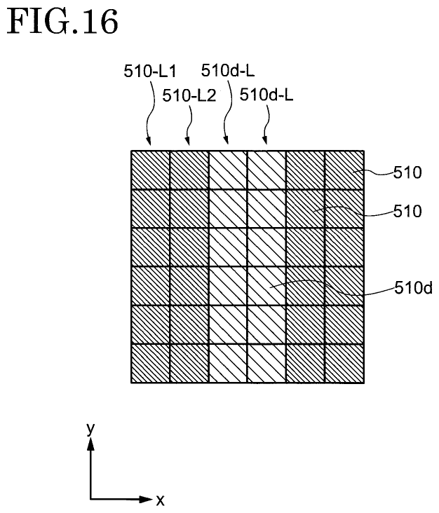

Here, the decrease of the difference value reflecting a defect of the semiconductor device 500 is described with reference to FIG. 16.

FIG. 16 is a schematic diagram showing difference values calculated when the reflective element 510 has a defect in a method for inspecting a semiconductor device according to an embodiment of the present invention.

FIG. 16 shows two adjacent rows of reflective elements 510d-L with difference values less than or equal to the threshold. When two adjacent signal lines SL extending in the y-direction are short-circuited, the voltage signal is not sufficiently applied to the liquid crystal in the reflective element 510d that is in the first state in step S320. Therefore, in the two adjacent rows of the reflective elements 510d-L in which the short circuit occurs, the capacitance C_{det} acquired in step S330 is close to the capacitance C_{det} of the reflective element 510 in the second state. In this case, the calculated difference value decreases in two adjacent rows of the reflective elements 510d-L. Although the defects in the two rows of the reflective elements 510d-L shown in FIG. 16 do not occur within the reflective element 510d, the defect in the signal line SL is reflected in the capacitance corresponding to the reflective element 510d. Therefore, in a method for inspecting a semiconductor device according to the present modification, it is possible to detect not only defects in the reflective element 510 but also defects in the signal line SL.

Although some modifications of a method for inspecting a semiconductor device according to an embodiment of the present invention are described above, it is also possible to combine these modifications in the present embodiment.

### Second Embodiment

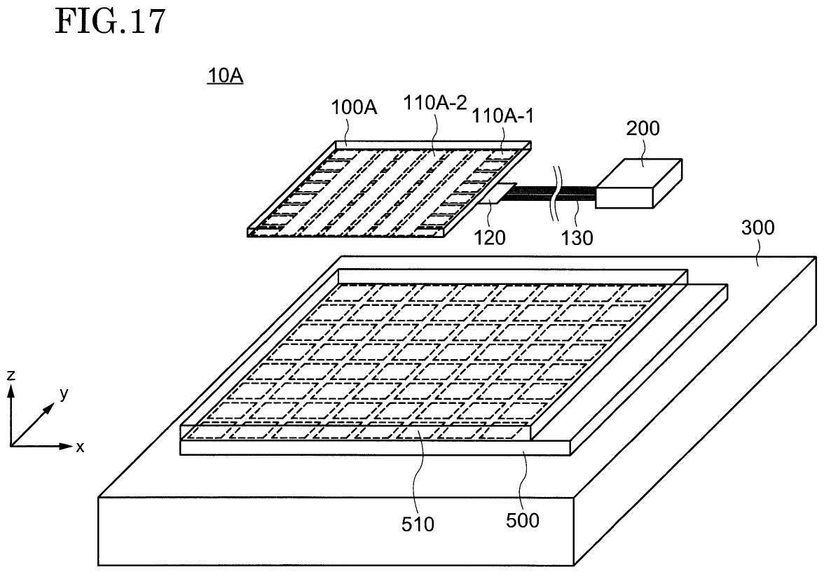

A method for inspecting a semiconductor device according to an embodiment of the present invention is described with reference to FIGS. 17 to 19.

### [1. Configuration of Inspection Equipment]

An inspection device 10A is used in a method for inspecting a semiconductor device according to an embodiment of the present invention. Therefore, a configuration of the inspection device 10A is described with reference to FIG. 17. In addition, the description of configurations that are the same as or similar to the above-described configurations may be omitted in the following description.

FIG. 17 is a schematic diagram showing the configuration of an inspection device 10A used in a method for inspecting a semiconductor device according to an embodiment of the present invention.

As shown in FIG. 17, the inspection device 10A includes a sensor head 100A, the control device 200, and the stage 300. The sensor head 100A includes a plurality of first sensor electrodes 110A-1 extending in the x direction and a plurality of second sensor electrodes 110A-2 extending in the y direction. The plurality of second sensor electrodes 110A-2 overlap the plurality of first sensor electrodes 110A-1 via an insulator. The plurality of first sensor electrodes 110A-1 and the plurality of second sensor electrodes 110A-2 are electrically connected to the plurality of terminals of the terminal portion 120, respectively. The signals from the control device 200 are input to the plurality of second sensor electrodes 110A-2, and the signals from the plurality of first sensor electrodes 110A-1 are input to the control device 200.

### [2. Acquisition of Capacitance Corresponding to Reflective Element]

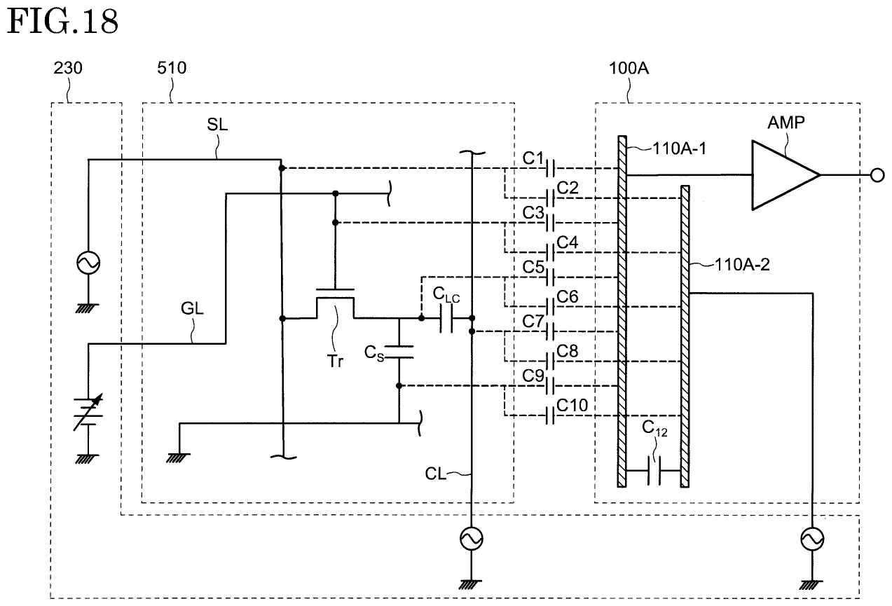

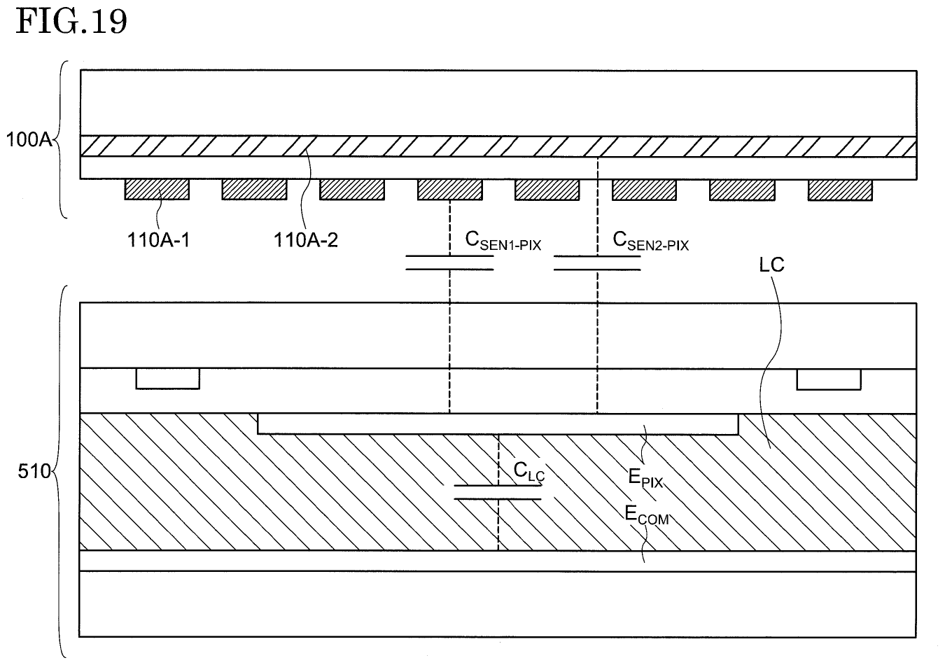

The acquisition of the capacitance corresponding to the reflective element 510 is described with reference to FIGS. 18 and 19.

FIG. 18 is a schematic circuit diagram illustrating a detection of capacitance by the first sensor electrode 110A-1 and the second sensor electrode 110A-2 in a method for inspecting a semiconductor device according to the embodiment of the present invention.

FIG. 18 shows a detection circuit of the sensor head 100A and the reflective element circuit of the reflective element 510. In addition, the detection circuit and the reflective element circuit are not limited to the configuration shown in FIG. 18. Further, FIG. 18 shows a portion in which one first sensor electrode 110A-1 and one second sensor electrode 110A-2 overlap each other with respect to one reflective element 510, for convenience of explanation.

The sensing circuit shown in FIG. 18 includes the first sensor electrode 110A-1, the second sensor electrode 110A-2, and an amplifier AMP. The AC voltage signal generated by the voltage signal generation section 230 of the control device 200 is input to the second sensor electrode 110A-2. At this time, an interelectrode capacitance C₁₂ is formed between the first sensor electrode 110A-1 and the second sensor electrode 110A-2.

When the first sensor electrode 110A-1 is brought close to the reflective element 510, various capacitances are generated between the first sensor electrode 110A-1 and the second sensor electrode 110A-2 (see capacitances C1 to C10 in FIG. 18). The interelectrode capacitance C₁₂ changes due to the influence of the capacitances formed by the reflective element 510 (the capacitances C1 to C10 and a liquid crystal capacitance C_{LC}, etc.). In this manner, the inspection device 10A can detect capacitance by a so-called mutual capacitance method, in which the change in the interelectrode capacitance C₁₂ is detected.

FIG. 19 is a schematic diagram illustrating a capacitance corresponding to the reflective element 510 in a method for inspecting a semiconductor device according to an embodiment of the present invention.

Although it is described in FIG. 18 that the portion in which one first sensor electrode 110A-1 and one second sensor electrode 110A-2 overlap each other corresponds to one reflective element 510, in reality a plurality of overlapping portions of the first sensor electrode 110A-1 and the second sensor electrode 110A-2 faces one reflective element 510, as shown in FIG. 19.

As shown in FIG. 19, a liquid crystal capacitance C_{LC} is formed by the liquid crystal LC sandwiched between the patch electrode E_{PIX} and the common electrode E_{COM}. Further, although the capacitance formed between the portion in which one first sensor electrode 110A-1 and one second sensor electrode 110A-2 overlap each other and one reflective element 510 is as described above, it is considered that the above capacitance is divided into a capacitance C_{SEN1-PIX} formed by the first sensor electrode 110A-1 and the reflective element 510 and a capacitance C_{SEN2-PIX} formed by the second sensor electrode 110A-2 and the reflective element 520, for convenience. In this case, the plurality of first sensor electrodes 110A-1 corresponding to the reflective element 510 can detect the capacitance C_{det} represented by Equation (2).

$$\begin{matrix}[ Equation 2 ] & \\ {C}_{det} = \frac{{C}_{SEN 1 - PIX} {C}_{LC}}{{C}_{SEN 2 - PIX} + {C}_{LC}} & ( 2 )\end{matrix}$$

When the state of the liquid crystal LC changes, the liquid crystal capacitance C_{LC} changes. Thus, as understood from equation (2), when the state of the liquid crystal LC changes, the capacitance C_{det} detected by the plurality of first sensor electrodes 110A-1 changes. Therefore, the capacitance acquisition section 240 can acquire the capacitance C_{det} corresponding to the reflective element 510 by selecting the plurality of first sensor electrodes 110A-1 and the plurality of second sensor electrodes 110A-2 corresponding to the reflective element 510.

### [3. Inspection Method of Semiconductor Device]

A method for inspecting a semiconductor device using the inspection device 10A is basically the same as the method for inspecting a semiconductor device described in the First Embodiment. Therefore, the description is omitted here.

As described above, in a method for inspecting a semiconductor device according to an embodiment of the present invention, the capacitance corresponding to each of the plurality of reflective elements 510 of the semiconductor device 500 can be acquired using the sensor head 100A including the plurality of first sensor electrodes 110A-1 and the second sensor electrodes 110A-2. The capacitance corresponding to the reflective element 510 reflects various defects in the reflective element 510, the signal line SL, and the gate line GL. Therefore, defects in the semiconductor device 500 can be easily determined based on the change in the capacitance corresponding to the reflective element 510.

Each of the embodiments described above as an embodiment of the present invention can be appropriately combined and implemented as long as they do not contradict each other. Additions, deletions, or design changes of constituent elements, or additions, omissions, or changes to conditions of steps as appropriate based on the respective embodiments are also included within the scope of the present invention as long as the gist of the present invention is provided.

Other effects which differ from those brought about by each of the embodiments described above, but which are apparent from the description herein or which can be readily predicted by those skilled in the art, are naturally understood to be brought about by the present invention.

What is claimed is:

1. A method for inspecting a semiconductor device comprising a plurality of reflective elements arranged in a matrix in an x direction and a y direction intersecting the x-direction, each of the plurality of reflective elements comprising a liquid crystal between a pair of non-transparent electrodes, comprising the steps of:
placing a sensor head comprising a plurality of sensor electrodes over the semiconductor device;
acquiring a first capacitance corresponding to each of the plurality of reflective elements via the plurality of sensor electrodes after inputting a first voltage signal to the semiconductor device so that a dielectric constant of the liquid crystal is in a predetermined first state in each of the plurality of reflective elements;
acquiring a second capacitance corresponding to each of the plurality of reflective elements via the plurality of sensor electrodes after inputting a second voltage signal to the semiconductor device so that a dielectric constant of the liquid crystal is in a predetermined second state in each of the plurality of reflective elements;
calculating a difference value between the first capacitance and the second capacitance; and
determining whether the difference value is less than or equal to a predetermined threshold value.

2. The method for inspecting a semiconductor device according to claim 1, wherein the plurality of sensor electrodes is arranged in a matrix in the x direction and the y direction.

3. The method for inspecting a semiconductor device according to claim 1, wherein the plurality of sensor electrodes comprises a plurality of first sensor electrodes extending in the x direction and a plurality of second sensor electrodes extending in the y direction.

4. The method for inspecting a semiconductor device according to claim 1, wherein the sensor head is placed so that the plurality of sensor electrodes is not in contact with the semiconductor device.

5. The method for inspecting a semiconductor device according to claim 1,
wherein one of the pair of non-transparent electrodes is a patch electrode configured to control an alignment of the liquid crystal, and
wherein in at least one of the x direction and the y direction, a width of each of the plurality of sensor electrodes is less than a width of the patch electrode.

6. A method for inspecting a semiconductor device comprising a plurality of reflective elements arranged in a matrix in an x direction and a y direction intersecting the x-direction, each of the plurality of reflective elements comprising a liquid crystal between a pair of non-transparent electrodes, comprising the steps of:
placing a sensor head comprising a plurality of sensor electrodes in a matrix in an x direction and a y direction over the semiconductor device;
acquiring a capacitance corresponding to each of the plurality of reflective elements via the plurality of sensor electrodes after inputting voltage signals to the semiconductor device so that a dielectric constant of the liquid crystal of one of two adjacent reflective elements in the x direction and the y direction is in a predetermined first state in the plurality of reflective elements and a dielectric constant of the liquid crystal of another of the two adjacent reflective elements is in a predetermined second state;
calculating a difference value between capacitances of the two adjacent reflective elements in each of the x direction and the y direction; and
determining whether the difference value is less than or equal to a predetermined threshold value.

7. The method for inspecting a semiconductor device according to claim 6, wherein the plurality of sensor electrodes is arranged in a matrix in the x direction and the y direction.

8. The method for inspecting a semiconductor device according to claim 6, wherein the plurality of sensor electrodes comprises a plurality of first sensor electrodes extending in the x direction and a plurality of second sensor electrodes extending in the y direction.

9. The method for inspecting a semiconductor device according to claim 6, wherein the sensor head is placed so that the plurality of sensor electrodes is not in contact with the semiconductor device.

10. The method for inspecting a semiconductor device according to claim 6,
wherein one of the pair of non-transparent electrodes is a patch electrode configured to control an alignment of the liquid crystal, and
wherein in at least one of the x direction and the y direction, a width of each of the plurality of sensor electrodes is less than a width of the patch electrode.

11. A method for inspecting a semiconductor device comprising a plurality of reflective elements arranged in a matrix in an x direction and a y direction intersecting the x-direction, each of the plurality of reflective elements comprising a liquid crystal between a pair of non-transparent electrodes, comprising the steps of:
placing a sensor head comprising a plurality of sensor electrodes in a matrix in an x direction and a y direction over the semiconductor device;
acquiring a capacitance corresponding to each of the plurality of reflective elements via the plurality of sensor electrodes after inputting voltage signals to the semiconductor device so that a dielectric constant of the liquid crystal of one of two adjacent reflective elements in the x direction is in a predetermined first state in the plurality of reflective elements and a dielectric constant of the liquid crystal of another of the two adjacent reflective elements is in a predetermined second state;
calculating a difference value between capacitances of the two adjacent reflective elements in the x direction; and
determining whether the difference value is less than or equal to a predetermined threshold value.

12. The method for inspecting a semiconductor device according to claim 11, wherein the plurality of sensor electrodes is arranged in a matrix in the x direction and the y direction.

13. The method for inspecting a semiconductor device according to claim 11, wherein the plurality of sensor electrodes comprises a plurality of first sensor electrodes extending in the x direction and a plurality of second sensor electrodes extending in the y direction.

14. The method for inspecting a semiconductor device according to claim 11, wherein the sensor head is placed so that the plurality of sensor electrodes is not in contact with the semiconductor device.

15. The method for inspecting a semiconductor device according to claim 11,
wherein one of the pair of non-transparent electrodes is a patch electrode configured to control an alignment of the liquid crystal, and
wherein in at least one of the x direction and the y direction, a width of each of the plurality of sensor electrodes is less than a width of the patch electrode.
